(19) United States
(12) Patent Application Publication
(10) Pub. No.: US 2008/0107831 A1
(43) Pub. Date: May 8, 2008

(54) Alignment material and liquid crystal display using the same

(75) Inventors: Yeon-Cu Kim, Asan-si (KR); Young-Kuil Joo, Asan-si (KR); Hye-Rhee Han, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/973,800

(22) Filed: Oct. 9, 2007

(30) Foreign Application Priority Data
Oct. 10, 2006 (KR) 2006-98572

(51) Int. Cl. C09K 19/02; C08F 283/00

(52) U.S. Cl. 428/1.2; 525/418

(57) ABSTRACT

Disclosed are an alignment material comprising a solvent, a polymer resin, and a cross-linking agent, and a liquid crystal display using the alignment material. The polymer resin is mixed with the solvent to have a weight percent ranging from about 4% to about 8% and includes an amic acid monomer having an amino group in one example. The cross-linking agent is mixed with the solvent to have a weight percent ranging from about 2% to about 20% and includes a diepoxy group which reacts with the amino group in one example. The liquid crystal display comprises two substrates facing each other, and an alignment layer formed at a top surface of at least one of the two substrates. The alignment layer is formed by curing the alignment material.

### CROSS-REFERENCE TO RELATED APPLICATION

This application relies for priority upon Korean Patent Application No. 2006-98572 filed on Oct. 10, 2006, the contents of which are herein incorporated by reference in its entirety.

### BACKGROUND OF THE INVENTION

1. Field of the Invention

The present invention relates to an alignment material and a liquid crystal display using the same. More particularly, the present invention relates to an alignment material capable of removing contaminating factors and a liquid crystal display having an alignment layer formed by using the alignment material.

2. Description of the Related Art

A liquid crystal display displays an image by using the optical characteristics of liquid crystal. The liquid crystal display includes a liquid crystal panel. The liquid crystal panel includes two substrates and a liquid crystal layer interposed between the two substrates. The liquid crystal is aligned in the liquid crystal layer, and the liquid crystal display adjusts the alignment direction of the liquid crystal to display the corresponding image.

The liquid crystal layer may be contaminated by various impurities, deteriorating a quality of the image of the liquid crystal display. The alignment direction of the liquid crystal is adjusted by an alignment layer formed on the two substrates, and the liquid crystal layer may be contaminated by the alignment layer. The alignment layer is formed by coating an alignment material, and the alignment material includes various compounds. Some of the compounds included in the alignment material remains in the alignment layer and may be introduced into the liquid crystal layer during the operation of the liquid crystal display, thereby contaminating the liquid crystal layer.

Meanwhile, in order to adjust the alignment direction of the liquid crystal, a rubbing process is performed. That is, a roller covered with cloth is rolled over the alignment layer to rub the alignment layer with the cloth. The rubbing process is to form scratches on the surface of the alignment layer using mechanical impact, and the alignment layer may be damaged during the rubbing process by the mechanical impact. If the alignment layer is damaged, the liquid crystal may not be adjusted in the desired direction, thereby deteriorating the image quality.

### SUMMARY OF THE INVENTION

Therefore, the present invention provides an alignment material capable of removing contaminating factors.

The present invention also provides a liquid crystal display having an alignment layer formed by using the alignment material to display high quality images.

In one aspect, an alignment material comprises a solvent, polymer resin mixed with the solvent to have a weight percent ranging from about 4% to about 8% and consisting of an amic acid monomer having an amino group, and a cross-linking agent mixed with the solvent to have a weight percent ranging from about 2% to about 20% and consisting of an diepoxy group which reacts with the amino group.

The cross-linking agent has a boiling point ranging from about 130° C. to about 230° C., and the cross-linking agent has a molecular weight ranging from about 50 to about 200. In addition, the polymer resin has the weight percent ranging from about 5% to about 7%, and the cross-linking agent has the weight percent ranging from about 10% to about 14%.

In another aspect, a liquid crystal display comprises two substrates, a liquid crystal layer and an alignment layer. The two substrates are provided facing each other. The liquid crystal layer is interposed between the two substrates. The alignment layer is formed at a top surface of at least one of the two substrates.

The alignment layer is formed by curing an alignment material, in which the alignment material comprises a solvent, polymer resin mixed with the solvent to have a weight percent ranging from about 4% to about 8% and consisting of an amic acid monomer having an amino group, and a cross-linking agent mixed with the solvent to have a weight percent ranging from about 2% to about 20% and consisting of an diepoxy group which reacts with the amino group.

Preferably, a boiling point of the cross-linking agent is lower than a curing temperature of the alignment material.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded perspective view illustrating a liquid crystal display according to an embodiment of the present invention;

FIGS. 2A through 2C are views illustrating the procedure of forming an alignment layer of a liquid crystal display shown in FIG. 1;

FIG. 3A is an enlarged view illustrating an internal structure of an alignment layer shown in FIG. 1; and

FIG. 3B is an enlarged view illustrating an internal structure of an alignment layer according to another embodiment of the present invention.

### DESCRIPTION OF THE EMBODIMENTS

Hereinafter, embodiments of the present invention will be explained in detail with reference to the accompanying drawings. However, the scope of the present invention is not limited to such embodiments and the present invention may be realized in various forms. The embodiments to be described below are nothing but the ones provided to bring the disclosure of the present invention to perfection and assist those skilled in the art to completely understand the present invention. The present invention is defined only by the scope of the appended claims. In addition, the size of regions shown in the drawings may be simplified or magnified for the purpose of clear explanation. Also, the same reference numerals are used to designate the same elements throughout the drawings.

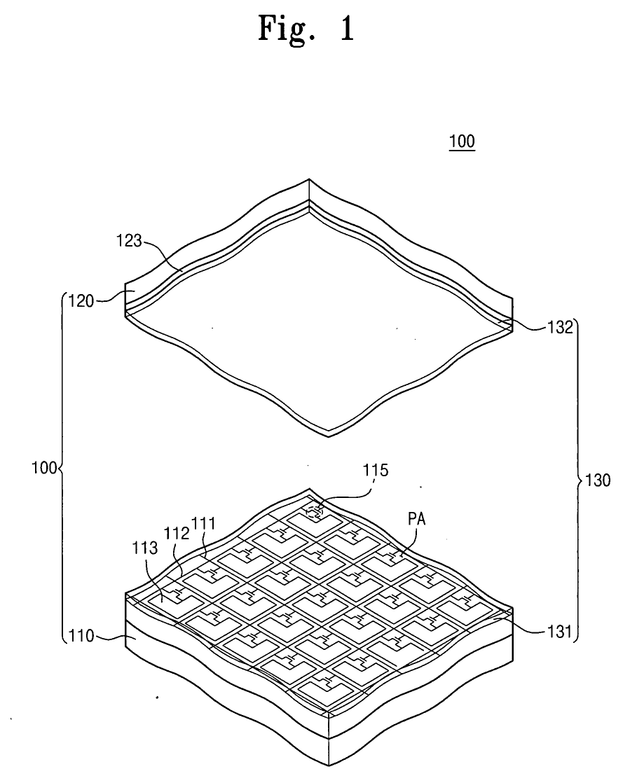

FIG. 1 is an exploded perspective view illustrating a liquid crystal display according to an embodiment of the present invention. Referring to FIG. 1, a liquid crystal display 100 including first and second substrates 110 and 120 is shown. A liquid crystal layer (not shown) having liquid crystal is interposed between the first and second substrates 110 and 120. A plurality of gate lines 111 and data lines 112 are formed on the first substrate 110. The gate lines 111 cross the data lines 112 to define pixel areas PA. Each of the pixel areas PA have the same structure, and each pixel area includes a pixel electrode 113 and a thin film transistor 115. The second substrate 120 includes a common electrode 123 facing the pixel electrodes 113. Alignment layers 130 are formed on the pixel electrodes 113 and the common electrode 123. The alignment layers 130 include a first alignment layer 131 on the first substrate 110 and a second alignment layer 132 on the second substrate 120.

The liquid crystal has an oval shape having a long-axis and a short-axis, and an alignment direction thereof is defined by the direction of the long-axis. When voltage is not applied to the pixel electrode 113 and the common electrode 123, the alignment direction of the liquid crystal is adjusted by the alignment layers 130. For instance, when the liquid crystal is twisted nematic liquid crystal, the liquid crystal is aligned parallel to the first and second substrates 110 and 120. In addition, the liquid crystal aligned parallel to the first substrate 110 and the liquid crystal aligned parallel to the second substrate 120 are perpendicular to each other, and the liquid crystal between the two substrates is continuously twisted.

The first and second substrates 110 and 120 are provided with polarizers (not shown) at outer surfaces thereof, in which transmission axes of the polarizers are perpendicular to each other. Light is provided, and the light is linearly polarized by the polarizer attached to the outer surface of the first substrate 110. As the linearly polarized light passes through the liquid crystal layer, the phase thereof changes according to the twisted liquid crystal. The phase changed light passes through the polarizer attached to the outer surface of the second substrate 120 to display the image.

During the operation of the liquid crystal display, gate signals are applied to the gate lines 111 to turn on the thin film transistor 115 connected with corresponding gate line. In addition, data signals corresponding to image information are applied to the data lines 112, so that a data voltage corresponding to the data signals is applied to the pixel electrode 113. At the same time, a constant common voltage is applied to the common electrode 123. An electric field derived from the voltage difference between the data voltage and the common voltage is formed between the first and second substrates 110 and 120. The liquid crystal has an anisotropic dielectric constant, so the liquid crystal is inclined relative to the first and second substrates 110 and 120 as an electric field is applied thereto.

With such an alignment state of the liquid crystal, the light is supplied to the liquid crystal layer. The light is linearly polarized by means of the polarizer attached to the outer surface of the first substrate 110, and as the linearly polarized light passes through the liquid crystal layer, the phase thereof changes due to the inclined liquid crystal. A phase change value varies according to an inclination degree of the liquid crystal. When the liquid crystal is inclined at a right angle, the linearly polarized light is not subject to the phase change, so the light does not pass through the polarizer attached to the outer surface of the second substrate 120. Thus, the liquid crystal display becomes a black state.

The inclined angle of the liquid crystal varies according to the strength of the electric field applied thereto. The degree of phase change of the light varies according to the inclined angle, and the image having a gray scale corresponding to the phase change degree may be displayed.

During the operation of the above liquid crystal display, the alignment direction of the liquid crystal is adjusted by the alignment layer 130 when the electric field is not applied thereto. The alignment layer 130 includes an alignment material. Hereinafter, the procedure of forming the alignment layer 130 by using the alignment material will be described.

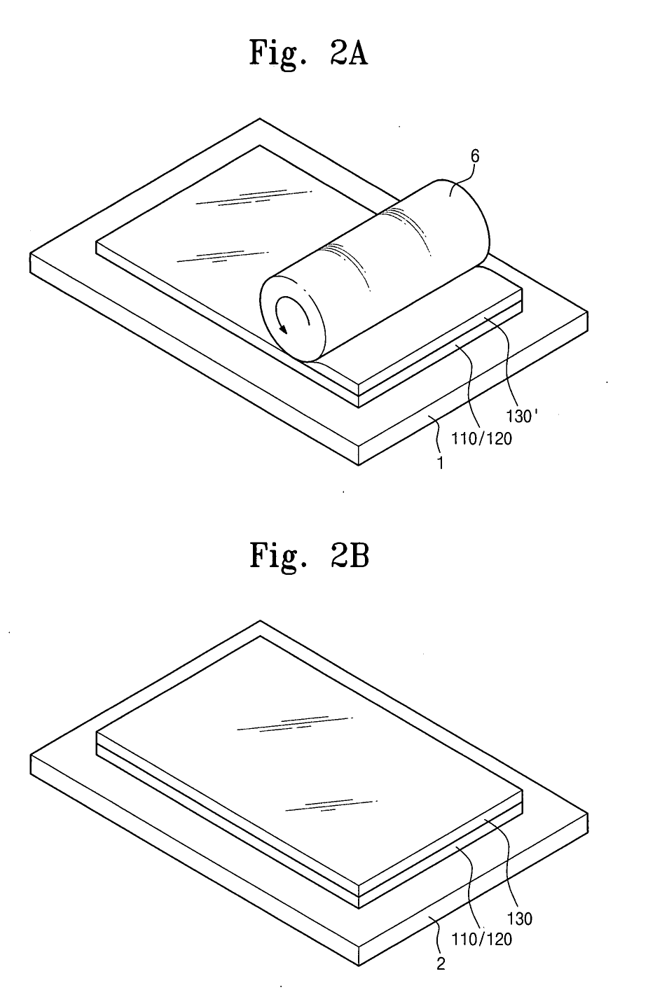

FIGS. 2A through 2C are views illustrating the procedure of forming the alignment layer of the liquid crystal display shown in FIG. 1.

Referring to FIG. 2A, a substrate 110 or 120 is settled on a stage 1. A roller 6 rolls on the substrate 110 or 120. An alignment material 130′ is supplied to the surface of the roller 6 by a dispenser (not shown) separately provided at the top of the roller 6. Therefore, in one example, as the roller 6 rolls on the substrate 110 or 120, the alignment material 130′ supplied to the surface of the roller 6 is printed on the surface of the substrate 110 or 120. In such a printing process, the alignment material 130′ can be coated on the substrate 110 or 120 through one rotation of the roller 6 by setting the roller 6 to have an appropriate size.

The alignment material 130′ may be coated on the substrate 110 or 120 through various methods as well as the printing process shown in FIG. 2A. For example, a spin coating method can be applied. That is, the alignment material 130′ is coated on the center of the substrate 110 or 120 while the stage 1 having the substrate 110 or 120 settled thereon is being rotated.

In one example, the alignment material 130′ includes a polymer resin, a cross-linking agent, and a solvent.

The polymer resin includes polyamic acid, and may further include a polyimide compound. The polyamic acid generally relates to the printing characteristics of the alignment layer 130, and the polyimide compound generally relates to the alignment characteristics of the liquid crystal by the alignment layer 130. The polyamic acid consists of a polyamic acid monomer having an amino group, and the polymer resin is formed by polymerizing a plurality of the polyamic acid monomers. The cross-linking agent links the polymer resins together to compensate for the strength of the polymer resins. The cross-linking agent has a diepoxy group which reacts with the amino group in the polymer resin.

The solvent dissolves the polymer resin and the cross-linking agent, in order that the alignment material 130′ is coated on the substrate 110 or 120 in a liquid state. The solvent has the largest composition ratio in the alignment material 130′. The solvent may be one of γ-butirolactone, ethyleneglycolbutylether, and N-methylpyrrolidone or may be a mixed solution having at least two of the three compositions.

Referring to FIG. 2B, the substrate 110 or 120 having the alignment material 130′ coated thereon is transferred to a curing furnace, and the substrate 110 or 120 is settled on a stage 2 provided in the curing furnace. The heat treatment is performed relative to the substrate 110 or 120 in the curing furnace, thereby forming an alignment layer 130. The alignment layer 130 may be the first alignment layer 131 or the second alignment layer 132.

The solvent in the alignment material 130′ is vaporized during the heat treatment. In addition, some of the polyamic acids in the polymer resin may change into polyimide compound through an imide reaction. The heat treatment is performed under a temperature of about 230° C. or less, and the polymer resin in the alignment layer 130 remains in the form of solid contents through the heat treatment. The cross-linking agent reacts with the polymer resin to link the solid contents with each other during the heat treatment. In this manner, since the solid contents are linked with each other, the strength of the alignment layer 130 is improved.

Meanwhile, if a vaporization speed of the solvent is too fast, the alignment material 130′ is non-uniformly spread on the substrate 110 or 120, thereby staining the alignment layer 130. Therefore, before putting the substrate 110 or 120 in the curing furnace, an additional process can be performed in a preliminary dryer such that the solvent can be slowly vaporized.

Referring to FIG. 2C, the substrate 110 or 120 is transferred onto a stage 3 from the curing furnace. A rubbing process is performed relative to the alignment layer 130 on the substrate 110 or 120. The rubbing process is performed by rolling a roller 7, which is covered with a rubbing cloth, over the substrate 110 or 120. A cloth including cotton or nylon-based fiber is used as the rubbing cloth. The roller 7 rolls in a predetermined direction. As the roller 7 rolls over the alignment layer 130, the rubbing cloth rubs the alignment layer 130, thereby forming scratches on the surface of the alignment layer 130. The alignment layer 130 may have predetermined directionality due to the scratches, and the liquid crystal is aligned on the alignment layer 130 in a predetermined direction according to the directionality. However, the rubbing process can be selectively performed according to the types of the liquid crystal used in the liquid crystal display, or can even be omitted.

In such a process of forming the alignment layer 130, some of the cross-linking agents may not react with the polymer resin but may remain in the alignment layer 130. The remaining cross-linking agents may diffuse into the liquid crystal layer in the liquid crystal display, and become a contaminating factor. Accordingly, the remaining cross-linking agents must be removed from the alignment layer 130.

In addition, the alignment layer 130 may be damaged by a mechanical impact caused by the rotation of the roller 7 during the rubbing process. Thus, to prevent the alignment layer 130 from being damaged, the alignment layer 130 must have sufficient strength. Therefore, in order to allow the alignment layer 130 to have the sufficient strength, a sufficient amount of the cross-linking agents must link the solid contents with each other during the heat treatment.

The alignment material 130′ satisfies the above-mentioned two conditions. Hereinafter, properties of the alignment material 130′ and effects thereof will be described with reference to the drawings.

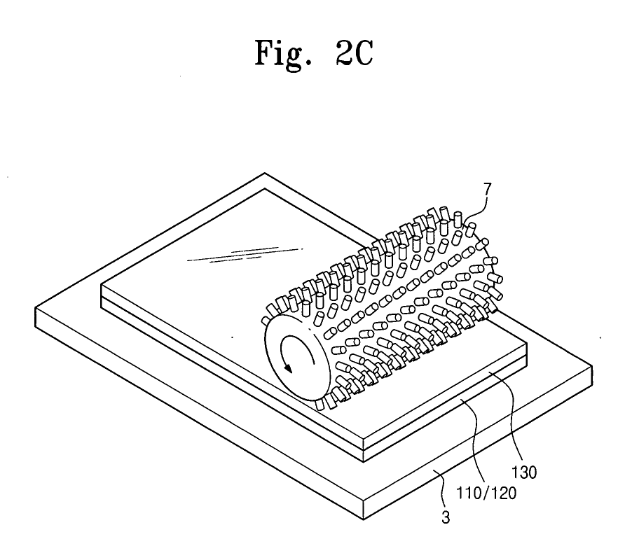

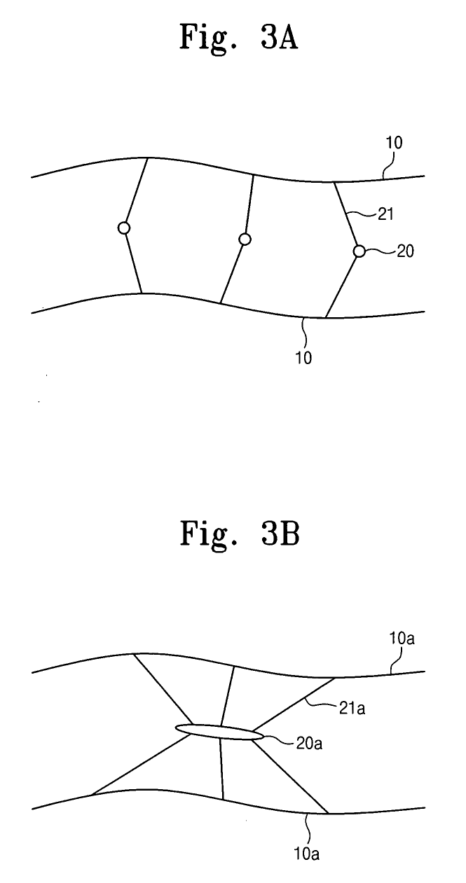

FIG. 3A is an enlarged view illustrating an internal structure of the alignment layer shown in FIG. 1, and FIG. 3B is an en larged view illustrating an internal structure of the alignment layer according to another embodiment of the present invention.

Referring to FIG. 3A, the alignment layer 130 includes a plurality of solid contents 10 which are formed by curing the polymer resin included in the alignment material 130′. The solid contents 10 are linked with each other through cross-linking agent particles 20 included in the alignment material 130′.

In FIG. 3A, the part where the cross-linking agent particle 20 and the solid content 10 are linked together is referred to as a linking branch 21. The cross-linking agent particle 20 has two linking branches 21 per particle in one example. The two linking branches 21 are used to link together two solid contents 10.

As the number of the linking branches 21 that link solid contents 10 together increases, the strength of the alignment layer 130 increases. In the present embodiment, the number of the linking branches 21 that link the solid contents 10 together may increase as follows. That is, as shown in FIG. 3A, if plural cross-linking agent particles 20 are used to link the solid contents 10 together, the number of the linking branches 21 that link the solid contents 10 increases corresponding to the number of the cross-linking agent particles 20.

Referring to FIG. 3B, cross-linking agent particle 20a may have six linking branches 21a per particle. The number of the linking branches 21a shown in FIG. 3B is for illustrative purposes only, and the number of the linking branches 21a may be more than six. In this manner, if the number of the linking branches 21a per cross-linking agent particle 20a increases, the alignment layer 130 may have sufficient strength even if the smaller number of the cross-linking agent particles 20a is used to link the solid contents 10a.

However, in order to increase the number of the linking branches 21a per cross-linking agent particle 20a, the cross-linking agent particle 20a must be a macromolecule having a large molecular weight. The macromolecular cross-linking agent particles 20a increase an intermolecular force, raising the boiling point. If the boiling point rises; the cross-linking agent particles 20a that are not used in linking the solid contents 10a remain in the alignment layer 130. This is because when the alignment layer 130 is formed through the heat treatment, the cross-linking agent particle 20a has a high boiling point, so the cross-linking agent particle 20a can not change into a gas phase, making it difficult to vaporize the cross-linking agent particle 20a. The remaining cross-linking agents 20a may diffuse into the liquid crystal layer and become a contaminating factor.

Referring again to FIG. 3A, if the number of the linking branches 21 per cross-linking agent particle 20 is small, the cross-linking agent particle 20 has a small molecular weight and the boiling point thereof lowers. Therefore, when the alignment layer 130 is cured through the heat treatment, the cross-linking agent particles 20, which do not participate in linking the solid contents 10, change into a gas phase, and are then vaporized.

As described above, according to the present embodiment, the cross-linking agent having a low molecular weight and a low boiling point is used to link the solid contents 10. As a result, unnecessary cross-linking agents, which are not used in linking, can be vaporized at the temperature under the curing temperature of the alignment layer 130. Accordingly, the liquid crystal is prevented from being contaminated by unnecessary cross-linking agents remaining in the alignment layer 130.

In addition, since the unnecessary cross-linking agents can be removed by vaporization, a sufficient amount of the cross-linking agents necessary for generating chemical reaction can be supplied. If the sufficient amount of the cross-linking agents is used, the sufficient amount of the cross-linking agents can participate in linking together the solid contents 10. As a result, the solid contents 10 can be linked with sufficient number of the linking branches 21, and the alignment layer 130 may have sufficient strength to endure against a mechanical pressure such as the rubbing process.

Hereinafter, the specific components and mixture ratio of the alignment material 130′. will be described.

The alignment material 130′ includes a large amount of a solvent, and a small amount of polymer resins and cross-linking agents. The solvent includes γ-butirolactone, ethyleneglycolbutylether and N-methylpyrrolidone. These components dissolve the polymer resins and the cross-linking agents, and have a boiling point lower than the curing temperature of the alignment layer 130 so that these components vaporize during the curing process for the alignment layer 130.

The polymer resin is mixed with the solvent to have a weight percent ranging from about 4% to about 8%, and the cross-linking agent is mixed with the solvent to have a weight percent ranging from about 2% to about 20%. With such a mixture ratio, the cross-linking agent has a weight percent that is about 0.5 to 2.5 times that of the polymer resin. Thus, in order to allow the polymer resin to sufficiently react with the cross-linking agent, the amount of the cross-linking agent mixed with the polymer resin has to be at least half the amount of the polymer resin. Since the reaction chance may increase proportionally to the weight percent of the cross-linking agent, the cross-linking agent preferably has greater weight percent than 0.5 times that of the polymer resin. In addition, even if some of the cross-linking agents are not used in the reaction because the weight percent of the cross-linking agent is large, such cross-linking agents may be vaporized during the heat treatment, so the weight percent of the cross-linking agent is not limited. However, if the amount of the cross-linking agent is excessive, the printing characteristics of the alignment material 130′ may be deteriorated.

In this manner, the cross-linking agent is preferred to have the weight percent which does not exceed the weight percent of the polymer resin more than 2.5 times. More preferably, the polymer resin has a weight percent ranging from about 5% to about 7%, and the cross-linking agent has a weight percent ranging from about 10% to about 14%, which is about two times larger than the weight percent of the polymer resin. In this case, the solvent has the remaining weight percent, that is, the weight percent excluding the polymer resin and the cross-linking agent.

As described above, the polymer resin in the alignment material 130′ includes an amic acid monomer having an amino group in one example. In addition, the cross-linking agent has a diepoxy group which reacts with the amino group. Each diepoxy group reacts with the amino groups included in the different polymer resins. The epoxy group reacts with the amino group to form a linking branch 21.

The cross-linking agent has the boiling point of 230° C. or less, in which the 230° C. is the curing temperature of the alignment layer 130. Particularly, the cross-linking agent has the boiling point ranging from about 130° C. to about 230° C., and has the molecular weight ranging from about 50 to about 200 which corresponds to the boiling point. For compounds having the diepoxy group, the boiling point and the molecular weight described above are as follows.

The cross-linking agent may include a cyclopentane compound described by chemical formula 1 as follows.

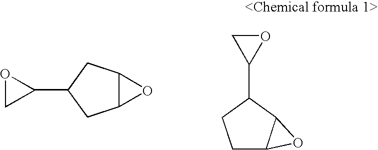

The cyclopentane has 5 carbons forming a loop, and the 5 carbons are all single-bonded. Two epoxy groups are bonded to any of the 5 carbons. The cyclopentane has two isomers according to the location whereto the epoxy groups are bonded, and the cross-linking agent may include at least one of the two isomers.

The cross-linking agent may include a cyclopentene compound described by chemical formula 2 as follows.

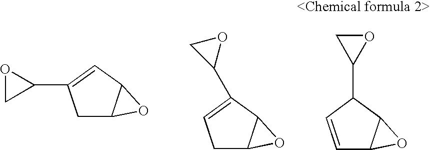

The cyclopentene has 5 carbons forming a loop, and the 5 carbons include a plurality of single bonds and one double bond. Two epoxy groups are bonded to any of the 5 carbons. The cyclopentene has three isomers according to the location of the double bond and the location whereto the epoxy groups are bonded, and the cross-linking agent may include at least one of the three isomers.

The cross-linking agent may include a cyclohexane compound described by chemical formula 3 as follows.

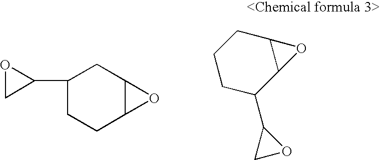

The cyclohexane has 6 carbons forming a loop, and the 6 carbons are all single-bonded. Two epoxy groups are bonded to any of the 6 carbons. The cyclohexane has two isomers according to the location whereto the epoxy groups are bonded, and the cross-linking agent may include at least one of the two isomers.

The cross-linking agent may include a cyclohexene compound described by chemical formula 4 as follows.

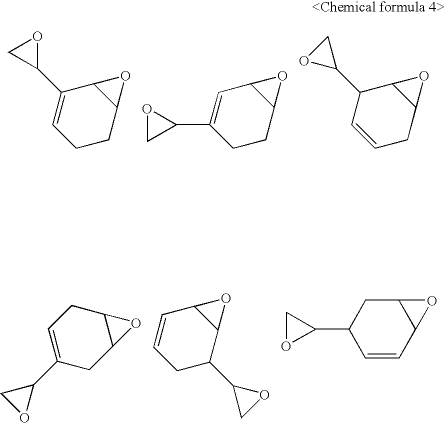

The cyclohexene has 6 carbons forming a loop, and the 6 carbons include a plurality of single bonds and one double bond. Two epoxy groups are bonded to any of the 6 carbons. The cyclohexene has six isomers according to the location of the double bond and the location whereto the epoxy groups are bonded, and the cross-linking agent may include at least one of the six isomers.

The cyclopentane, cyclopentene, cyclohexane and cyclohexene compounds consist of the carbon included in the diepoxy group, and have approximately 7 to 8 carbons so that the molecular weight is 150 or less. As the molecular weight becomes smaller, the intermolecular force becomes weaker so the boiling point becomes lower. For example, 4-vinyl-1-cyclohexene diepoxide included in the chemical formula 3 has the molecular weight of 140.2 and the boiling point of 227 under an atmospheric pressure.

The cross-linking agent may include a compound described by chemical formula 5 as follows.

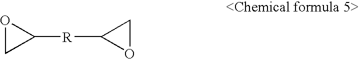

In chemical formula 5, R is representative of functional groups such as amides (—NH—CO—), esters (—CO—O—), ethers (—O—), sulfides (—S—), sulfoxides (—SOO—), hydroxides (—OH), halides (—F, —Cl, —Br, —I), imides (—CO—N—CO—), aza groups (—N—), amines (—NH₂), azo groups (—N═N—), aldehydes (—CO—H), carboxy groups (—CO—), anhydrides (—CO—O—CO—) and urea groups (—NH—CO—NH—). Among the functional groups, especially esters (—CO—O—), ethers (—O—), sulfides (—S—), halides (—F, —Cl, —Br, —I), aldehydes (—CO—H), carboxy groups (—CO—) and anhydrides (—CO—O—CO—) exhibit an excellent reactivity.

In chemical formula 5, R may be any of hydrocarbons having 0 through 10 carbons. When R has no carbon, the compound of the chemical formula 5 consists of the carbons included in the epoxy groups so as to have 4 carbons. In this case, the compound of the chemical formula 5 is 1,3-butadiene diepoxide having the molecular weight of 86.09. The 1,3-butadiene diepoxide has the boiling point ranging from about 56° C. to about 58° C. under 25 mmHg, and presumed to have the boiling point ranging from about 150° C. to about 160° C. under atmospheric pressure.

When R has at least one carbon, the compound of the chemical formula 5 includes a plurality of isomers according to the number of the carbon. For instance, if the R is a hydrocarbon having 6 carbons, the 6 carbons may be bonded in various forms as shown in chemical formula 6 below.

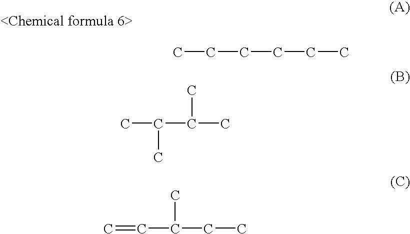

In chemical formula 6, as shown in (A), the 6 carbons form a main chain and all the carbons in the main chain are single-bonded. As shown in (B), all 6 carbons form single bonds, but 4 of the 6 carbons form the main chain and the remaining 2 carbons may be bonded to the sides of the main chain. As shown in (C), 1 of the 6 carbons is bonded to the side of the main chain, and some of the carbons may have a double bond.

Chemical formula 6 is illustrative of R in chemical formula 5, in which R is a hydrocarbon having 6 carbons. Therefore, the hydrocarbons bonded in various forms may be included as well as the forms shown in chemical formula 6. However, when comparing the molecule, in which the carbons are linearly formed along the main chain, with the molecule, in which some carbons are bonded at the sides as well as the main chain, the boiling points of the molecules are different from each other, even though the molecules have the same carbon numbers. In general, the molecule having some carbons bonded at the sides as well as the main chain has a higher boiling point. Accordingly, in the case of the molecule having some carbons bonded at the sides, R in the chemical formula 5 is preferred to have 6 carbons or less.

As described above, the cross-linking agent may include at least one of various compounds shown in chemical formulas 1 through 5. The cross-linking agent reacts with the polymer resin, as follows.

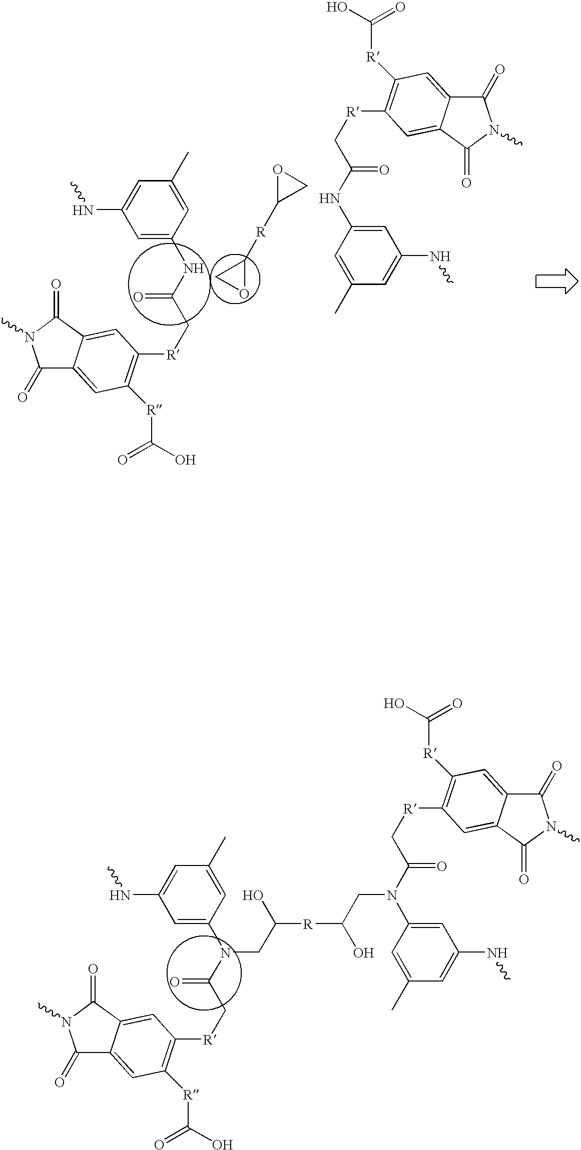

In the chemical reaction, R′ and R″ included in the polyamic acid represent general formulas of various compounds. Although the chemical reaction shows an illustrative example of the compound having the chemical formula 5 used as the cross-linking agent, the compounds having the chemical formulas 1 to 4 can also react with the polymer resin through a chemical reaction similar to that of the compound having the chemical formula 5.

As shown in the chemical reaction, the epoxy group included in the cross-linking agent reacts with the amino group included in the polyamic acid of the polymer resin, and the carbon in the epoxy group bonds with the nitrogen in the amino group. In the chemical reaction, two epoxy groups included in the cross-linking agent are bonded with the amino groups in the different polyamic acids, respectively. As a result, two different polyamic acids are linked together.

According to the embodiments, sufficient amount of the cross-linking agents, which can be used in the reaction with the polymer resin, is provided so that the alignment layer having a high strength can be formed. In addition, since the cross-linking agent has a low boiling point, the cross-linking agents that are not used in the reaction are vaporized from the alignment layer and easily removed. Accordingly, the liquid crystal is substantially prevented from being contaminated by the remaining cross-linking agents.

Although embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. An alignment material, comprising:
a solvent;
a polymer resin mixed with the solvent to have a weight percent ranging from about 4% to about 8%, the polymer resin including an amic acid monomer having an amino group; and
a cross-linking agent mixed with the solvent to have a weight percent ranging from about 2% to about 20%, the cross-linking agent including a diepoxy group which reacts with the amino group.

2. The alignment material of claim 1, wherein the cross-linking agent has a boiling point ranging from about 130° C. to about 230° C.

3. The alignment material of claim 2, wherein the cross-linking agent has a molecular weight ranging from about 50 to about 200.

4. The alignment material of claim 3, wherein the polymer resin has a weight percent ranging from about 5% to about 7%, and the cross-linking agent has a weight percent ranging from about 10% to about 14%.

5. The alignment material of claim 1, wherein the solvent comprises at least one selected from the group consisting of γ-butirolactone, ethyleneglycolbutylether, and N-methylpyrrolidone.

6. The alignment material of claim 1, wherein the cross-linking agent comprises at least one cyclopentane compound selected from the group expressed by the following chemical formulas:

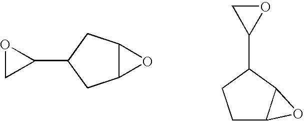

7. The alignment material of claim 1, wherein the cross-linking agent comprises at least one cyclopentene compound selected from the group expressed by the following chemical formulas:

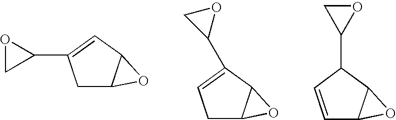

8. The alignment material of claim 1, wherein the cross-linking agent comprises at least one cyclohexane compound selected from the group expressed by the following chemical formulas:

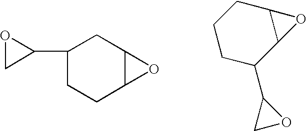

9. The alignment material of claim 1, wherein the cross-linking agent comprises at least one cyclohexene compound selected from the group expressed by the following chemical formulas:

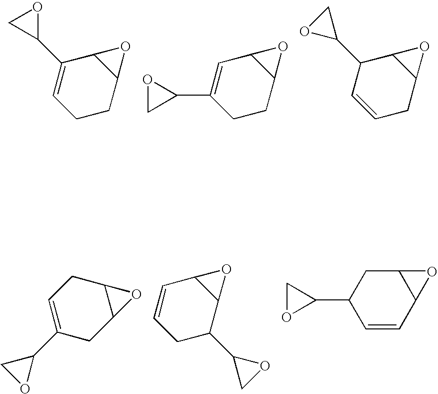

10. The alignment material of claim 1, wherein the cross-linking agent comprises a compound expressed by 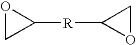
wherein R represents any one of an amide (—NH—CO—), an ester (—CO—O—), an ether (—O—), a sulfide (—S—), a sulfoxide (—SOO—), a hydroxide (—OH), a halide (—F, —Cl, —Br, —I), an imide (—CO—N—CO—), an aza (—N—), an amine (—NH₂), an azo (—N═N—), an aldehyde (—CO—H), a carboxy (—CO—), an anhydride (—CO—O—CO—), a urea (—NH—CO—NH—), and a hydrocarbon having a carbon number ranging from 0 to 10.

11. The alignment material of claim 10, wherein the hydrocarbon has 6 carbons or less in a main chain thereof.

12. A liquid crystal display, comprising:
two substrates facing each other;
a liquid crystal layer interposed between the two substrates; and
an alignment layer formed at a top surface of at least one of the two substrates,
wherein the alignment layer is formed by curing an alignment material including:
a solvent;
polymer resin mixed with the solvent to have a weight percent ranging from about 4% to about 8%, the polymer resin including an amic acid monomer having an amino group; and
a cross-linking agent mixed with the solvent to have a weight percent ranging from about 2% to about 20%, the cross-linking agent including a diepoxy group which reacts with the amino group.

13. The liquid crystal display of claim 12, wherein a boiling point of the cross-linking agent is lower than a curing temperature of the alignment material.

14. The liquid crystal display of claim 13, wherein the cross-linking agent has the boiling point ranging from about 130° C. to about 230° C.

15. The liquid crystal display of claim 14, wherein the cross-linking agent has a molecular weight ranging from about 50 to about 200.

16. The liquid crystal display of claim 15, wherein the polymer resin has a weight percent ranging from about 5% to about 7%, and the cross-linking agent has a weight percent ranging from about 10% to about 14%.

17. The liquid crystal display of claim 12, wherein the solvent comprises at least one selected from the group consisting of γ-butirolactone, ethyleneglycolbutylether, and N-methylpyrrolidone.

18. The liquid crystal display of claim 12, wherein the cross-linking agent comprises at least one cyclopentane compound selected from the group expressed by the following chemical formulas:

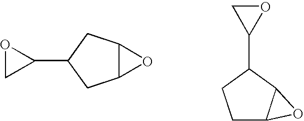

19. The liquid crystal display of claim 12, wherein the cross-linking agent comprises at least one cyclopentene compound selected from the group expressed by the following chemical formulas:

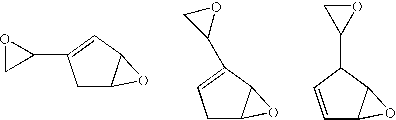

20. The liquid crystal display of claim 12, wherein the cross-linking agent comprises at least one cyclohexane compound selected from the group expressed by the following chemical formulas:

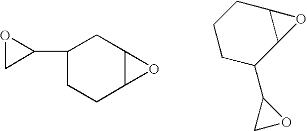

21. The liquid crystal display of claim 12, wherein the cross-linking agent comprises at least one cyclohexene compound selected from the group expressed by the following chemical formulas:

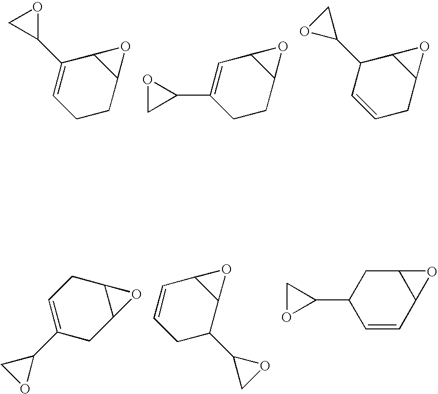

22. The liquid crystal display of claim 12, wherein the cross-linking agent comprises a compound expressed by 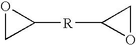
wherein R represents any one of an amide (—NH—CO—), an ester (—CO—O—), an ether (—O—), a sulfide (—S—), a sulfoxide (—SOO—), a hydroxide (—OH), a halide (—F, —Cl, —Br, —I), an imide (—CO—N—CO—), an aza (—N—), an amine (—NH₂), an azo (—N═N—), an aldehyde (—CO—H), a carboxy (—CO—), an anhydride (—CO—O—CO—), a urea (—NH—CO—NH—), and a hydrocarbon having a carbon number ranging from 0 to 10.

23. The liquid crystal display of claim 22, wherein the hydrocarbon has 6 carbons or less in a main chain thereof.

24. The liquid crystal display of claim 12, wherein the alignment layer is treated through a rubbing process.
